(19) United States
(12) Patent Application Publication
(10) Pub. No.: US 2013/0038564 A1
(43) Pub. Date: Feb. 14, 2013

(54) Touch Sensitive Device Having Dynamic User Interface

(71) Applicant: Kelvin Ho, San Francisco, CA (US)

(72) Inventor: Kelvin Ho, San Francisco, CA (US)

(73) Assignee: GOOGLE INC., Mountain View, CA (US)

(21) Appl. No.: 13/206,761

(22) Filed: Aug. 10, 2011

(51) Int. Cl. G06F 3/045

(52) U.S. Cl. 345/174

(57) ABSTRACT

A device adapted to be held by a user includes a touch sensitive display screen that outputs a touch a signal that indicates a position on the touch sensitive display screen that is touched by a user. A touch sensitive element has one or more sensors that output a hand signal that indicates a position on the touch sensitive element that is touched by the user. A processor is operable to display a user interface on the touch sensitive display screen, determine a display position based at least in part on the hand signal, display an interactive element of the user interface on the touch sensitive display screen at the display position, and selectively initiate a process when the touch signal indicates that the user has touched a position on the touch sensitive display screen that corresponds to the display position.

### TECHNICAL FIELD

The disclosure relates to the field of touch sensitive devices, and more particularly, to the field of user interfaces for touch sensitive devices.

### BACKGROUND

A touch screen is an electronic display device, such as a liquid crystal display, that is able to detect the presence and location of a touch on the surface of the display. Touch screens are becoming common features of computers, tablet computers, mobile phones, and other consumer products. Touch screen based devices often have user interfaces that respond when they are touched by a user. Users manipulate these devices by touching them with their fingers or thumbs or by touching them with a handheld implement, such as a stylus.

Handheld touch screen devices are operated by a user who holds the device using one or both hands and manipulates the user interface either using their thumbs or using a hand that is not holding the touch screen device. This mode of use has proven very effective for small-scale devices such as mobile phones.

Because mobile phones are typically small, there are few possible variations for holding the device, and the screen is small enough relative to the size of the human hand that all portions of the user interface are easily accessible, regardless of how the device is held. Larger scale hand held touch screen devices typically require the user to change the way in which the device is held to access portions of the user interface.

### SUMMARY

Touch screen devices and methods relating to touch screen devices are taught herein. One device adapted to be held by a user includes a touch sensitive display screen that outputs a touch a signal that indicates a position on the touch sensitive display screen that is touched by a user. The device also includes a touch sensitive element adjacent to the touch sensitive display screen having one or more sensors that output a hand signal that indicates a position adjacent to the touch sensitive display element that is touched by the user. The device also includes a processor that is operable to display a user interface on the touch sensitive display screen, determine a display position based at least in part on the hand signal, display an interactive element of the user interface on the touch sensitive display screen at the display position, and selectively initiate a process when the touch signal indicates that the user has touched a position on the touch sensitive display screen that corresponds to the display position.

Another device adapted to be held by a user that is taught herein includes a touch sensitive display screen that outputs a touch signal that indicates a position on the touch sensitive display screen that is touched by a user. The device also includes a touch sensitive housing that is connected to the touch sensitive display screen and has one or more sensors that output a hand signal that indicates a position on the touch sensitive housing that is touched by the user. The device also includes a processor that is operable to display a user interface on the touch sensitive display screen, determine at least a first hand position based on the hand signal, determine a display position based at least in part on the first hand position, display an interactive element of the user interface on the touch sensitive display screen at the display position, and selectively initiate a process when the touch signal indicates that the user has touched a position on the touch sensitive display screen that corresponds to the display position.

A method taught herein includes the steps of receiving a touch signal that indicates a position on a touch sensitive display screen that is touched by a user; receiving a hand signal that indicates a position adjacent to the touch sensitive display screen that is touched by the user; displaying a user interface on the touch sensitive display screen; determining a display position based at least in part on the hand signals; displaying an interactive element of the user interface on the touch sensitive display screen at the display position; and selectively initiating a process of the touch signal indicates that the user has touched a position on the touch sensitive display screen that corresponds to the display position.

### BRIEF DESCRIPTION OF THE DRAWINGS

The various features, advantages and other uses of the present apparatus will become more apparent by referring to the following detailed description and drawings in which:

FIG. 1 is a block diagram of a device that is adapted to be held by a user;

FIG. 2 is a top view illustration of the device of FIG. 1;

FIG. 3 is an end cross-sectional illustration of the device of FIG. 1;

FIGS. 4A-4C are illustrations depicting an exemplary hand position and display position of the device;

FIGS. 4D-4F are illustrations depicting an exemplary hand position and an exemplary display position of an interactive element of the user interface of the device; and

FIG. 5 is a flowchart showing an exemplary process for determining the display position.

### DETAILED DESCRIPTION

Touch screen tablet computers commonly have a form factor that allows them to be held in many ways. This often gives rise to a situation where the user's hands aren't positioned near key elements of the user interface that is displayed on a screen of the device. The disclosure herein is directed to devices and methods where the position of the user's hand on the device is detected, and an interactive element of the user interface is dynamically rendered so that the interactive element is always positioned near the user's hands.

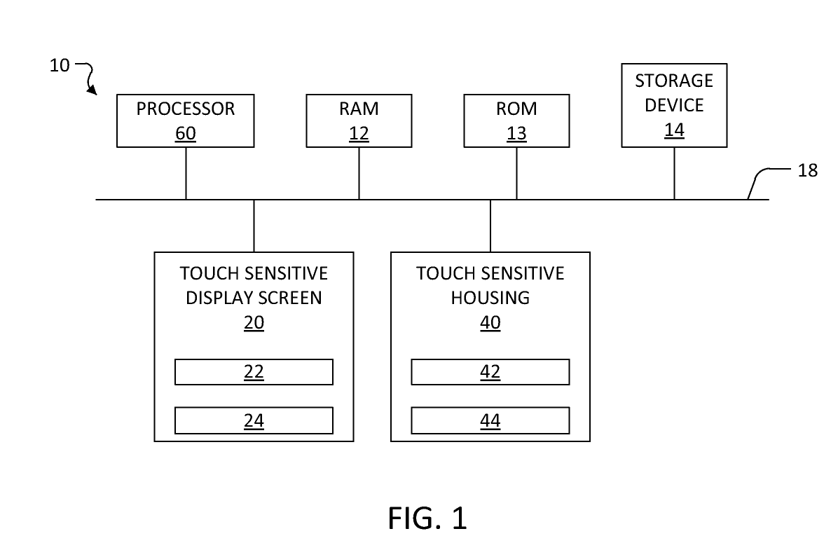

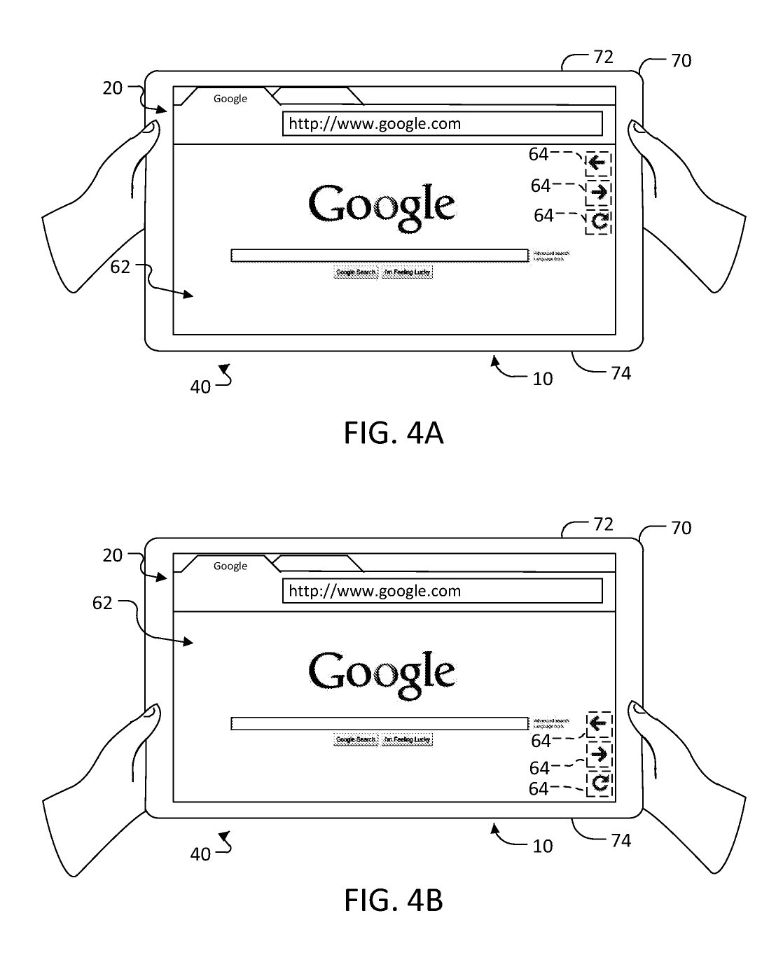

As shown in FIGS. 1-3, a device 10 that is adapted to be held by a user includes a touch sensitive display screen 20, a touch sensitive housing 40, and a processor 60.

As an example, the device 10 can also include memory such as RAM 12 and ROM 13. A storage device 14 can be provided in the form of any suitable computer readable medium, such as a non-volatile memory device or a hard disk drive. The touch sensitive display screen 20, the touch sensitive housing 40, the processor, the RAM 12, the ROM 13, and the storage device 14 are all connected to one another by a bus 18.

The touch sensitive display screen 20 is operable to display images in response to a video signal and is also operable to output a touch signal that indicates a position on the touch sensitive display screen 20 that is touched by a user. The touch signal is generated in response to contact or proximity of a portion of the user's body with respect to the touch sensitive display screen 20. The touch signal can also be generated in response to contact or proximity of an implement, such as a stylus.

The touch sensitive display screen 20 can be implemented using any one of a number of well-known technologies that are suitable for performing the functions described herein with respect to the touch sensitive display screen 20. Any suitable structure now know or later devised can be employed as the touch sensitive display screen 20. Exemplary technologies that can be employed to generate the touch signal include resistive touch sensing, surface acoustic wave touch sensing, capacitive touch sensing, and other suitable technologies.

As an example, the touch sensitive display screen 20 can include a touch screen 22 that is positioned on top of a display 24. The touch screen 22 is substantially transparent, such that the display 24 is visible through the touch screen 22.

The touch screen 22 and the display 24 are sized complementary to one another. The touch screen 22 can be approximately the same size as the display 24 and is positioned with respect to the display 24 such that the touchable area of the touch screen 22 and the viewable area of the display 24 are substantially coextensive. In this example, the touch screen 22 is a capacitive touch screen. Other technologies can be employed, as previously noted. In this example, the display 24 is a liquid crystal display that is operable to display images in response to a video signal.

The touch sensitive housing 40 is connected to the touch sensitive display screen 20 and outputs a hand signal that indicates a position on the touch sensitive housing 40 that is touched by the user. A number of technologies and configurations can be employed for the touch sensitive housing 40. The touch sensitive housing 40 can include a housing 42 and a touch sensitive element 44. The housing 42 can include a front surface 46, a peripheral surface 48, and a back surface 50. To connect the housing 42 to the touch sensitive display screen 20, an opening 52 is formed in the housing 42 and is bordered at its outer periphery by the front surface 46.

Other configurations can be used for the housing 42. As one example, the front surface 46 can be omitted if the touch sensitive display screen 20 is sized such that it occupies the entire front of the device 10. In such a configuration, the opening 52 is bordered at its outer periphery by the peripheral surface 48.

The touch sensitive element 44 is positioned on or in the housing 42 in any suitable configuration, and has one or more sensors that output a hand signal that indicate a position on the touch sensitive element 44 that that is touched by the user. Depending on the configuration and technology selected for the touch sensitive element 44, the touch sensitive element 44 can be positioned on an interior surface of the housing 42, can be embedded in the housing 42, or can extend through the housing 42 in one or more locations.

As an example, the touch sensitive element 44 can be positioned adjacent to the touch sensitive display screen 20. In this configuration, the hand signal that is output by the touch sensitive element 44 indicates a position adjacent to the touch sensitive display screen 20 that is touched by the user. As another example, the touch sensitive element 44 can be positioned on the housing 42, such that the hand signal indicates a position on the housing 42 that is touched by the user. As another example, the touch sensitive element 44 can be positioned on the peripheral surface 48 of the housing 42, such that the hand signal indicates a position on the peripheral surface 48 of the housing 42 that is touched by the user. As another example, the touch sensitive element 44 can be positioned on the back surface 50 of the housing 42, such that the hand signal indicates a position on the back surface 50 of the housing 42 that is touched by the user.

The touch sensitive element 44 can be constructed to use in any suitable technology by which the hand signal can be generated. Thus, structures employing technologies suitable to recognize the presence of a touch and to also identify the position of the touch are suitable for use as the touch sensitive element 44. The touch sensitive element 44 can be configured to output the hand signal as a position relative to a reference point on the housing 42. The position can be expressed as a one-dimensional position or a two-dimensional position.

As an example, the touch sensitive element 44 can be configured to sense touch at positions that are arranged in a one-dimensional array adjacent to the touch sensitive display screen 20, in which case the hand signal would be in the form of a one-dimensional position with respect to a reference point. This can be accomplished by providing the touch sensitive element 44 with multiple sensors that are positioned in a one-dimensional array. As another example, the touch sensitive element 44 can be configured to sense touch at positions that are arranged in a one-dimensional array around the peripheral surface 48 of the housing 42, which would produce the hand signal in the form of a one-dimensional position with respect to a reference point. As another example, the touch sensitive element 44 can be configured to sense touch at positions that are arranged a two-dimensional array, in which case the hand signal is produced as a two-dimensional position that is referenced with respect to a reference point on the housing 42 of a device 10. This can be accomplished by providing the touch sensitive element 44 with multiple sensors that are positioned in a two-dimensional array.

A variety of known sensor configurations can be utilized to produce the hand signal in the form of a one-dimensional position. For example, a one-dimensional array of electrodes can be provided on the interior of the housing 42 for sensing the user's hands on the basis of capacitance, where the housing 42 serves as a dielectric. Likewise, a number of sensing technologies can be used to produce the hand signal as a two dimensional position, including sensing elements indisposed in a two-dimensional array or plural fields of linear electrodes that extend in different directions in a crossing configuration. Using these known technologies, the hand signal can simultaneously indicate multiple positions on the housing 42 that are touched by the user. In addition to the technologies discussed herein, other technologies now known or later developed can be utilized for the touch sensitive element 44 of the touch sensitive housing 40.

As an example of a two-dimensional hand signal, the touch sensitive element 44 can be positioned adjacent to the back surface 50 of the housing 42, such that the hand signal indicates a position on the back surface 50 of the housing 42 that is touched by the user. This hand signal can be in the form of a two-dimensional position that is referenced with respect to a predetermined reference point on the housing 42.

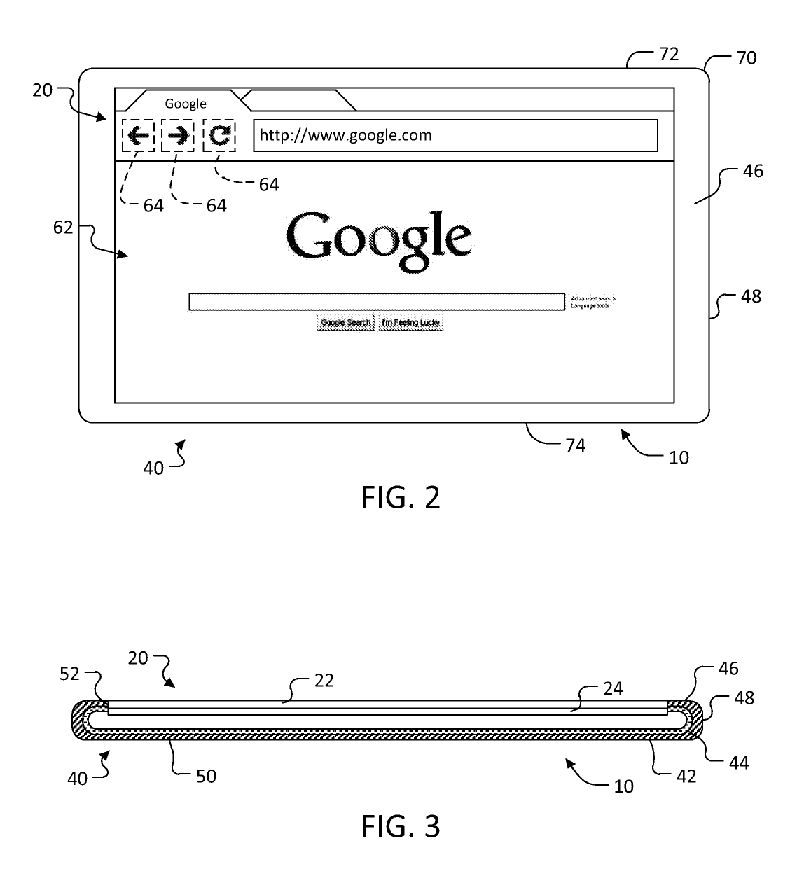

The processor 60 is operable to display a user interface 62 on the touch sensitive display screen 20. In FIG. 2, a web browser displaying a website is depicted as an example of the user interface 62. The user interface 62 includes a variety of interactive elements 64 that control primary functions of the user interface 62. In this example, the interactive elements 64 include a back button, a forward button, and a refresh button, which are commonly found in web browsers and control primary functions of the web browser relating to navigation. The interactive elements 64 are not limited by this example, however, and could include any desired interactive elements 64. The interactive elements 64 can vary based on the active application, usage context, and other factors.

Each of the interactive elements 64 can be manipulated by the user by way of the touch sensitive display screen 20 in order to initiate a process. The processor 60 receives the touch signal from the touch sensitive display screen 20 and initiates a process corresponding to the interactive element 64 that has been touched when the touch signal indicates that the user has touched a position on the touch sensitive display screen 20 that corresponds to the position at which the interactive element 64 is displayed. Thus, when the user touches a portion of the touch sensitive display screen 20 that corresponds to the back button of the interactive elements 64, a touch signal is generated by the touch sensitive display screen 20, is received by the processor 60, and is interpreted by the processor 60 and correlated to the position at which the back button of the interactive elements 64 was displayed by the processor 60. After this correlation has been made, the processor 60 initiates the process associated with the back button.

The processor 60 is operable to reposition one or more of the interactive elements 64 based upon the way that the user is holding the device 10 as indicated by the hand signal. Initially, the interactive elements 64 are at a default position or at a position that was previously determined based on the hand signal. The processor 60 determines a display position for the interactive elements 64 based at least in part on the hand signal. The processor 60 then repositions the interactive elements 64 by displaying the interactive elements 64 of the user interface 62 on the touch sensitive display screen 20 at the display position. Then, the processor 60 selectively initiates the process corresponding to the interactive element 64 when the touch signal indicates that the user has touched a position on the touch sensitive display screen 20 that corresponds to the display position.

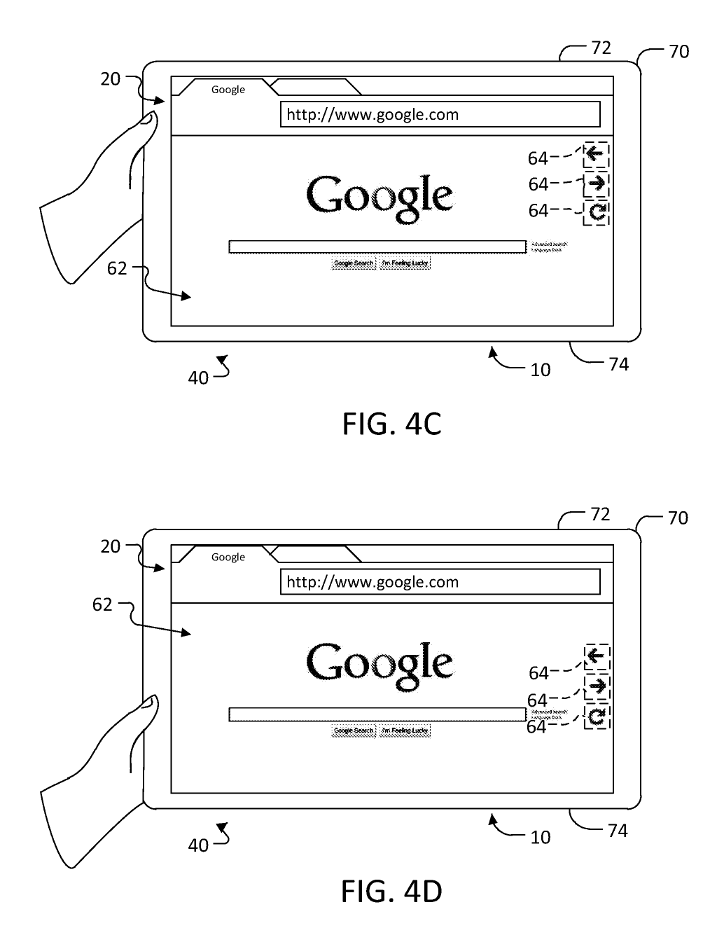

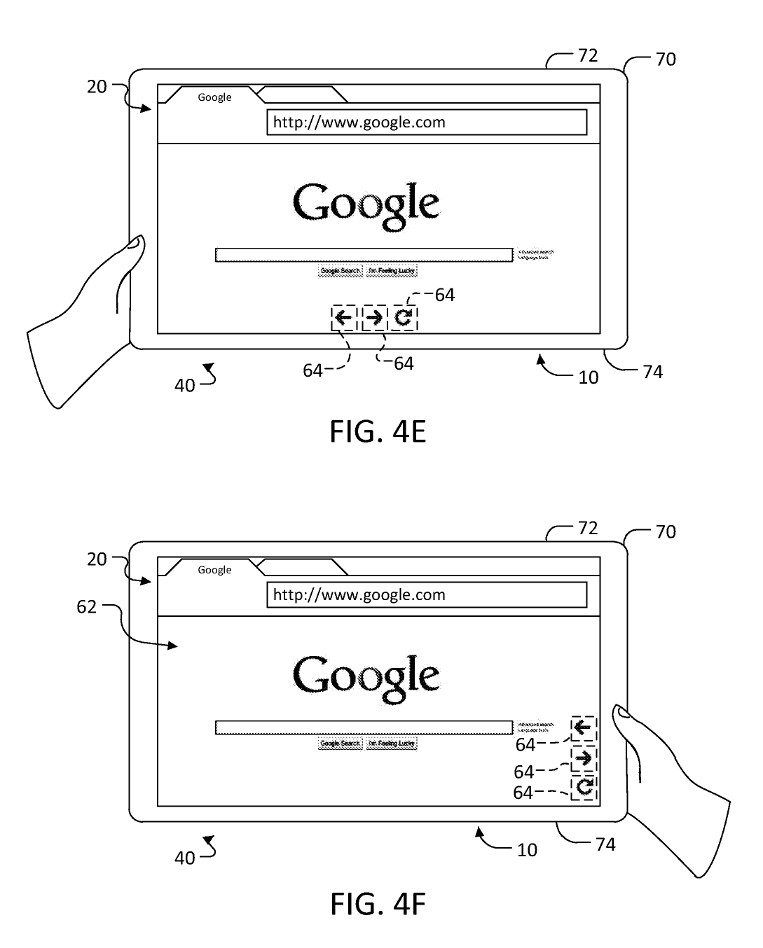

The display position can be determined in a manner that displays the interactive elements 64 of the user interface 62 on the touch sensitive display screen 20 at or near the position adjacent to the touch sensitive display screen 20 that is touched by the user, as shown in FIGS. 4A-4B. The determination of the display position can be made by a calculation of the display position based on the hand signal. Alternatively, the determination of the display position can be made by selecting a predefined display position from two or more predefined display positions based on the hand signal.

The display position can be calculated based on a hand position. This is done by first calculating the hand position based on the hand signal and then calculating the display position based on the hand position. The hand position can be an average position that is determined based on the hand signal.

As an example of calculating the display position based on the hand position, the hand signal can indicate a distance of the user's hand with respect to a predetermined reference point adjacent to the touch sensitive display screen 20, such as a corner 70 of the housing 42. This distance forms the basis of a calculation of the display position by the processor 60. This calculation can be designed to correlate the display position to the position of the user's hand. As a result, as the user moves their hand from the upper end 72 of the housing 42 (FIG. 4A) to the lower end 74 of the housing 42 (FIG. 4B), the interactive elements 64 can be moved in a manner that corresponds to movement of the user's hand, such that the interactive elements 64 remain adjacent to or nearby the user's hand.

The calculation of the display position based on the hand position described above can be modified based on a user preference that is stored by the processor 60. This user preference can be a handedness setting, which indicates whether the user is left-handed or right-handed. In this case, the interactive elements 64 are positioned along the right edge of the touch sensitive display screen 20 if the user is right-handed and are positioned along the left edge of the touch sensitive display screen 20 if the user is left-handed. If it is determined that the user is holding the device 10 with one hand instead of two hands, a different set of user preference settings can be utilized to determine the display position, as will be explained.

The calculation of the display position based on the hand position described above can be modified based on the size of the user's hand. This can be accomplished by calculating a hand size for the user based on the hand signal on the basis of the surface area of the housing 42 that is simultaneously touched by the user's hand. The hand signal is used as the basis for calculating an average hand position, and the hand size is utilized to estimate the distance between the average hand position and the end of a user's thumb. This is taken into account when calculating the final display position.

The result of the calculations described previously can be that the hand position is in the form of a distance from a first predetermined reference point that is adjacent to the touch sensitive display screen 20 and that the display position is in the form of a distance from a second predetermined reference point on the touch sensitive display screen 20.

As an alternative to the calculations that were described previously, the display position can be determined by calculating the hand position based on the hand signal, and then selecting the display position based on the hand position. As an example, the display position can be selected from two or more predefined positions based on the hand signal. Thus, the processor 60 can determine whether the user's hand is positioned in one of one or more predefined zones on the housing 42 based on the hand signal. The processor 60 then selects a predefined position for the interactive element 64 that corresponds to the zone on the housing 42 where the housing 42 is being held.

In any of the foregoing examples, the orientation of the device 10, namely whether the device 10 is being held in portrait orientation, can be considered in calculation or selection of the display position.

Although the examples made previously reflect use of the device 10 when held by two hands, the processor 60 is operable to calculate or select the display position when the device 10 is held by a single hand of the user, as shown in FIGS. 4C-4F. The calculation or selection employed in this circumstance can be selected based on a user-preference setting, or can be determined by the processor 60 based on usage context.

As an example, when the processor 60 detects, based on the hand signal and the handedness setting, that the user is holding the device 10 with their off-hand, the interactive elements 64 can be positioned opposite the user's off-hand. Thus, when the user's off-hand is holding the device 10 at its side, the interactive elements 64 can be positioned on the touch sensitive display screen 20 at the opposite side of the device 10. This can be done by calculating the display position such that the display position is directly opposite the user's off-hand (FIG. 4C).

In an alternative example, when the device 10 is held by the user's off-hand, the processor 60 can select the display position from one of two or more predefined locations based on the position of the user's off-hand as indicated by the hand signal (FIGS. 4D-4E). The processor 60 can be operable to store a user preference in the form of a predetermined display position on the touch sensitive display screen 20 at which the interactive elements 64 are to be positioned when the device 10 is held with the user's off-hand. The user preference can be in the form of a selection of one of the bottom edge or the opposite side edge, along which the interactive elements 64 are to be positioned when the device 10 is held by the user's off-hand.

In another alternative example, when the device 10 is held by one hand, the processor 60 can set the display position nearby or adjacent to the hand that is touching the housing 42, based on the hand signal (FIG. 4F).

The foregoing examples explain that the interactive elements 64 are positioned based on the position of one of the user's hands, as indicated by the hand signal. In all of these examples, the positions of both of the user's hands can be determined, and separate sets of the interactive elements 64 can be placed according to the position of each hand. In some implementations, different elements 64 can be placed differently according to the hand signal. For example, one set of elements can be placed near the detected position of a user's right hand while a different set of elements can be placed near the detected position of a user's left hand.

Also, the foregoing examples explain that the interactive elements 64 are positioned based on the position of the user's hand, as indicated by the hand signal that is currently generated (including a signal or absence of a signal that indicates that the device is not being held with one or more of the user's hands). It should be understood, however, determining a position for the interactive elements 64 based on the hand signal also includes tracking the position of the user's hands over time, and determining one or more ideal predetermined positions for the interactive elements 64 based on the user's behaviors.

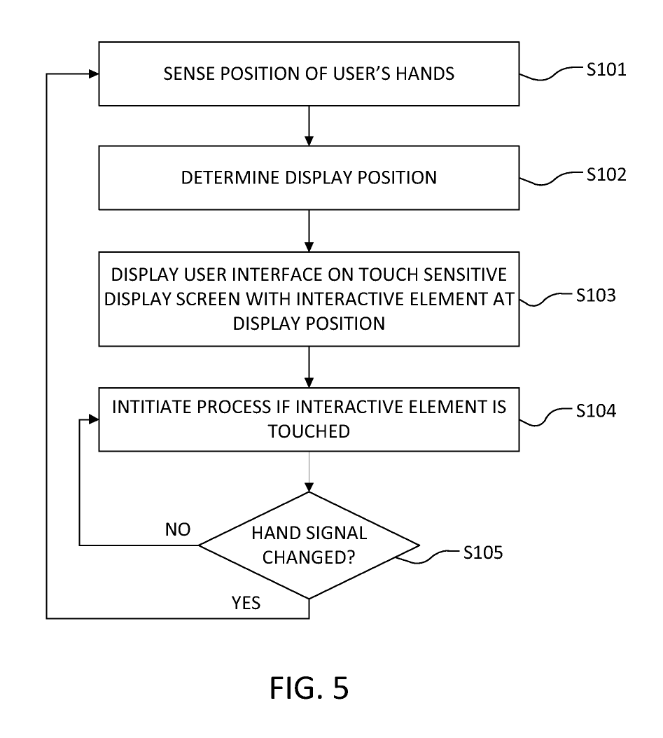

Operation of the device 10 will now be explained with reference to FIG. 5.

In step S101, the device 10 senses the user's hands using the touch sensitive element 44 and generates the hand signal. In step S102, the processor 60 determines a display position based at least in part on the hand signal. The display position can be selected or calculated as previously described. The determination of the display position can include calculation of the hand position. The display position can be further based in part on other factors, such as a user preference setting for the size of the interactive elements 64, or based on a hand size as detected by the hand signal.

In step S103, the processor 60 displays the user interface 62 on the touch sensitive display screen 20, including the interactive element 64, which is positioned on the touch sensitive display screen 20 at the display position. In Step S104, the processor 60 selectively initiates a process corresponding to the interactive element 64 when the touch signal indicates that the user has touched a position of the touch sensitive display screen 20 that corresponds to the display position.

In step S105, the processor 60 determines whether the hand signal has changed, indicating that the user's hands have moved with respect to the touch sensitive housing 40 of the device 10. If the hand signal has changed, the display position can be updated, such as by returning to step S101.

While this disclosure includes what is presently considered to be the most practical and preferred embodiment, it is to be understood that the disclosure is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. A device adapted to be held by a user, comprising:
a touch sensitive display screen that outputs a touch signal that indicates a position on the touch sensitive display screen that is touched by a user;
a touch sensitive element having one or more sensors that output a hand signal that indicates a position on the touch sensitive element that is touched by the user; and
a processor operable to display a user interface on the touch sensitive display screen, determine a display position based at least in part on the hand signal, display an interactive element of the user interface on the touch sensitive display screen at the display position, and selectively initiate a process when the touch signal indicates that the user has touched a position on the touch sensitive display screen that corresponds to the display position.

2. The device of claim 1, wherein the display position is determined such that the interactive element of the user interface is displayed on the touch sensitive display screen near the position on the touch sensitive element that is touched by the user.

3. The device of claim 1, wherein the display position is determined by calculating at least a first hand position based on the hand signal and calculating the display position based on the first hand position.

4. The device of claim 3, wherein first hand position is a distance from a first predetermined reference point adjacent to the touch sensitive display screen and the display position is a distance from a second predetermined reference point on the touch sensitive display screen.

5. The device of claim 1, wherein the display position is determined by calculating at least a first hand position based on the hand signal and selecting the display position based on the first hand position.

6. The device of claim 5, wherein the display position is selected from two or more predefined positions based on the hand signal.

7. The device of claim 1, wherein the display position is determined by calculating at least a first hand position based on the hand signal, calculating a hand size based on the first hand position, and calculating the display position based on the first hand position and the hand size.

8. The device of claim 1, wherein the processor is operable to store a user preference and determine the display position based in part on the user preference.

9. The device of claim 8, wherein the user preference is a handedness setting.

10. The device of claim 8, wherein the user preference is a selection of an edge of the touch sensitive display screen.

11. The device of claim 8, wherein the user preference is a predefined display position on the touch sensitive display screen.

12. The device of claim 1, further comprising:
a housing connected to the touch sensitive display screen, wherein the one or more sensors of the touch sensitive element are positioned in or on the housing.

13. The device of claim 1, further comprising:
a housing connected to the touch sensitive display screen, wherein the hand signal indicates a position on the housing that is touched by the user.

14. The device of claim 1, further comprising:
a housing connected to the touch sensitive display screen, the housing having a peripheral edge that surrounds the touch sensitive display screen, wherein the one or more sensors of the touch sensitive display are positioned in or on the peripheral edge of the housing.

15. The device of claim 1, further comprising:
a housing connected to the touch sensitive display screen, the housing having a peripheral edge that surrounds the touch sensitive display screen, wherein the hand signal indicates a position on the peripheral edge of the housing that is touched by the user.

16. The device of claim 1, further comprising:
a housing connected to the touch sensitive display screen, the housing having a back surface opposite the touch sensitive display screen, wherein the one or more sensors of the touch sensitive display are positioned in or on the back surface of the housing.

17. The device of claim 1, further comprising:
a housing connected to the touch sensitive display screen, the housing having a back surface opposite the touch sensitive display screen, wherein the hand signal indicates a position on the back surface of the housing that is touched by the user.

18. The device of claim 1, wherein the touch signal is generated in response to either of contact or proximity of either of a portion of the user's body or an implement with respect to the touch sensitive display screen.

19. A device adapted to be held by a user, comprising:
a touch sensitive display screen that outputs a touch signal that indicates a position on the touch sensitive display screen that is touched by a user;
a touch sensitive housing connected to the touch sensitive display screen having one or more sensors that output a hand signal that indicates a position on the touch sensitive housing that is touched by the user; and
a processor operable to display a user interface on the touch sensitive display screen, determine at least a first hand position based on the hand signal, determine a display position based at least in part on the first hand position, display an interactive element of the user interface on the touch sensitive display screen at the display position, and selectively initiate a process when the touch signal indicates that the user has touched a position on the touch sensitive display screen that corresponds to the display position.

20. A method, comprising:
receiving a touch signal that indicates a position on a touch sensitive display screen that is touched by a user;
receiving a hand signal that indicates a position adjacent to the touch sensitive display screen that is touched by the user;
displaying a user interface on the touch sensitive display screen;
determining a display position based at least in part on the hand signal;
displaying an interactive element of the user interface on the touch sensitive display screen at the display position; and
initiating a process when the touch signal indicates that the user has touched a position on the touch sensitive display screen that corresponds to the display position.
